(19) United States
(12) Patent Application Publication
(10) Pub. No.: US 2006/0265586 A1
(43) Pub. Date: Nov. 23, 2006

(54) Method and system for double secured authenication of a user during access to a service by means of a data transmission network

(76) Inventors: Estelle Transy, Moulineaux (FR); Frederic Delmond, Paris (FR); Sebastian Nguyen Ngoc, Chatillon (FR)

Correspondence Address: FISH & RICHARDSON P.C., P.O. BOX 1022, MINNEAPOLIS, MN, 55440-1022, US

(21) Appl. No.: 10/565,571

(22) PCT Filed: Jul. 13, 2004
(86) PCT No.: PCT/FR04/01849

§ 371 Date: Aug. 2, 2006

(30) Foreign Application Priority Data
Jul. 24, 2003 (FR) 0309086

(51) Int. Cl. H04L 9/00

(52) U.S. Cl. 713/155

(57) ABSTRACT

The invention relates to a method for authentication of a user during access to services provided by a data transmission network (5) consisting in transmitting a random number to a user terminal (11), cryptographically calculating authentication data of a user with two actuators (6, 7, 8) of the network (5) with the aid of secret keys proposed by the user, introducing identification data and calculated authentication data into the access request and in transmitting said access request by the terminal (11) to an access controller (10) which transmits a respective authentication request containing the identification and authentication data of the user to each actuator, carrying out an identification procedure (28, 29) by each actuator on the basis of the user identification and authentication data containing in the authentication requests and emitting authentication reports containing authentication results to the terminal (11). Method for authenticating a user when accessing services offered by a data transmission network (5), in which: a random number is transmitted to a user terminal (11); data for authenticating the user to at least two entities (6, 7, 8) of the network (5) is calculated by cryptography using secret keys specific to the user, the terminal (11) inserts, in an access request, the calculated identification and authentication data, and transmits the request to an access controller (10) which transmits, to each of the two entities, a respective authentication request containing user identification and authentication data; each of the entities carries out an authentication procedure (28, 29) based on user identification and authentication data, contained in the authentication requests, and transmits authentication reports containing the results of the authentication procedures, to be sent to the terminal (11).

This invention relates to the provision of services accessible by means of a data transmission network, such as services based on an IP (Internet Protocol) transport, accessible in particular by the Internet, or voice over IP services.

Currently, when a user wishes to access such a service, he or she must connect to the IP network by means of an access network and a service provider (FS) such as an Internet access provider. To this end, the user must first be authenticated by an authentication server of the service provider. To do this, the user must transmit and identifier in the form identifierFS@domainFS and a password. Such an authentication enables the service provider to customize its services, for example by transmitting a welcome page to the user in which the user's name appears.

Once the user is connected to the Internet, he or she can access other services which can also involve user identification and authentication so as to offer the user high value-added services. For example, an online Internet banking service requires an access network operator, an Internet access provider and the bank concerned. Access to a company's Intranet network requires at least an access network operator and the company concerned.

Several authentications can therefore be carried out during a single connection. As these authentications are carried out by various network entities, they are carried out separately, requiring the user to perform several authentication procedures. The ergonomics thus offered to the user therefore appear to be poor and tedious.

In addition, it appears that the authentication procedures currently used by service providers, and which are based on providing an identifier and a password, provide security that is mediocre, and, in any case, inadequate for enabling an entity to act as a trusted third party with regard to other service providers.

In the case of access networks, the current authentication procedures carried out during IP/PPP (Point-to-Point Protocol) connections via a STN network (Switched Telephone Network), ISDN (Integrated Services Digital Network) or ADSL (Asymmetric Digital Subscriber Line), do not make it possible to carry out an authentication at the access network level for PPP connections. Generally, the ANO/ITO network operator (Access Network/IP Transport Operator) cannot use the information transmitted by the user to be authenticated by the service provided, for the purpose of identifying the user, because it does not control this information which is managed by another administrative domain.

There is also a secure authentication procedure based on a challenge/response mechanism that has been standardized, for example, by the CHAP protocol (Challenge Handshake Authentication Protocol). However, this procedure is designed to carry out a secure authentication of a single independent entity, and must therefore be carried out again for each entity requiring authentication.

This invention aims to overcome these disadvantages by proposing a method enabling an authentication to be carried out for more than one independent entity on the network. This objective is achieved by providing a method for authenticating a user during an attempt to access an entity of a data transmission network, which method includes steps in which:
a user terminal transmits, to an entity of the network, an access request containing data for identifying and authenticating the user to the entity, wherein the access request is transmitted by means of the network to an authentication server of the entity,
the authentication server carries out a user authentication procedure, on the basis of identification and authentication data contained in the access request, and
the authentication server transmits, to the user terminal, a response message containing the result of the user authentication by the authentication server.

According to the invention, this method further includes steps in which:
a random number is transmitted to the terminal prior to the transmission of the access request,
data for authenticating the user with two network entities is calculated using at least one predefined cryptographic algorithm and at least one secret key specific to the user,
the terminal inserts, into the access request, data for identifying the user to said network entities and the calculated authentication data, and
the terminal transmits the access request to an access controller which transmits, to each of the two entities, a respective authentication request containing the data for identifying and authenticating the user to said network entities, contained in the access request,
authentication servers of each of the entities carry out a user authentication procedure, on the basis of user identification and authentication data, contained in the authentication requests, and
authentication reports containing results of the authentication procedures carried out by the authentication servers of each of said network entities are transmitted to the terminal.

At least one of the authentication data items is advantageously calculated by a module connected to the terminal.

According to an embodiment of the invention, this method includes a preliminary step in which the terminal establishes a connection with a specialized server by means of the network, and the random number is generated and transmitted to the terminal by the specialized server after the connection has been established.

According to another embodiment of the invention, the access request transmitted by the terminal is transmitted to the specialized server which inserts therein the random number used to calculate the authentication data, and the access request is then transmitted to the access controller which inserts the random number into the authentication requests transmitted to the two entities.

According to yet another embodiment of the invention, the authentication procedures carried out by the authentication servers of the entities include a step of searching for the secret key of the user on the basis of the identification data contained in the authentication request, a step of calculating an authentication data item by executing the cryptographic algorithm with the secret key of the user and the random number contained in the authentication request, and a step of comparing the authentication data contained in the authentication request with the calculated authentication data, wherein the user is properly authenticated if the authentication data contained in the authentication request corresponds to the calculated authentication data.

According to yet another embodiment of the invention, the network entities include a plurality of entities among access providers offering Internet access to the user, IP service providers, and an. IP transport and access network operator.

The identification data inserted into the access request is advantageously in the following form: “IdA@DomainA”in which:
“IdA” represents the identifier for identifying the user to the network entity,
“DomainA” represents the identifier of the network entity in the network, with the access controller determining the entities to whom the authentication requests will be transmitted on the basis of the “DomainA” identifiers of the network entity contained in the access request.

The steps of authenticating the user by the authentication servers of the entities are advantageously carried out in succession.

Alternatively, the steps of authenticating the user by the authentication servers of the entities are performed substantially simultaneously.

The random number from which the authentication data is calculated is preferably a random number which is modified in each connection attempt.

According to another embodiment of the invention, the user authentication procedures are performed in accordance with the CHAP protocol.

The invention also relates to a system for authenticating a user during an attempt to access an entity of a data transmission network to which network entities are connected, and to which user terminals can gain access by means of access networks, which system includes:
means provided in each user terminal for transmitting access requests to a network entity, which requests contain data for identifying and authenticating the user to the network entity, and
at least one authentication server for each of the network entities, designed to identify and authenticate the users according to identification and authentication data contained in the access requests received.

According to the invention, each user terminal includes means for receiving a random number when a connection with the network is established, cryptographic calculating means for applying at least one predefined cryptographic algorithm to the random number received so as to obtain data for authenticating the user to at least two network entities, and means for inserting, into each access request transmitted, data for identifying the user to two network entities and the calculated authentication data, wherein the system also comprises an access controller including means for receiving requests from user terminals and transmitted via said network, means for extracting, from each of the access requests, the data for identifying and authenticating the user to at least two network entities, and means for transmitting, to each of the two entities, a respective authentication request containing the data for identifying and authenticating the user to the two entities, contained in the access request.

According to an embodiment of the invention, this system includes an external module designed to connect to each of the user terminals and including means for receiving the random number from the terminal to which it is connected, cryptographic calculating means for carrying out the predefined cryptographic algorithm on the basis of the random number, and for transmitting, to the terminal, at least one data item for authenticating the user to a network entity, obtained by the cryptographic calculations.

The predefined algorithm is advantageously a cryptographic algorithm using secret key specific to the user and stored by the module.

According to another embodiment of the invention, the module is a smart card, and each terminal comprises means for connecting to a smart card.

According to another embodiment of the invention, the access controller also includes means for receiving user authentication reports, transmitted by the entities in response to the authentication requests, and means for transmitting, to the user terminal, an authentication report on the basis of the reports received from the entities.

According to yet another embodiment of the invention, this system also includes a specialized server connected to the network so as to be connected to the user terminals after a connection has been established between the terminal and the network, wherein the specialized server includes means for generating and transmitting a random number to each of the terminals with which a connection is established, and means for inserting the random number into each of the access requests transmitted by the terminals.

The specialised server is preferably an HTTP server comprising an interface with the RADIUS protocol.

Also preferably, the access controller is a RADIUS Proxy.

According to yet another embodiment of the invention of the system, each network entity includes means for storing secret user keys, means for determining the data for authenticating the user to the entity by applying the predefined algorithm to the random number received in the authentication request and to the secret user key, and for comparing the result obtained to the user authentication data received in the authentication request, wherein the user is properly authenticated by the entity only if the result of the cryptographic calculation obtained is identical to the authentication data contained in the authentication request.

A preferred embodiment of the invention will be described below, by way of a non-limiting example, with reference to the appended drawings, in which:

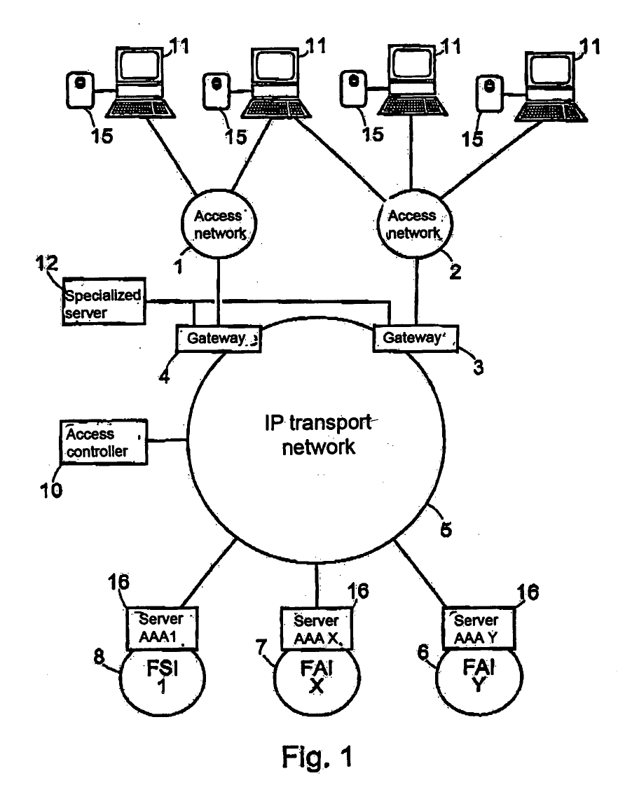

FIG. 1 diagrammatically shows the architecture of a system for providing services, according to the invention;

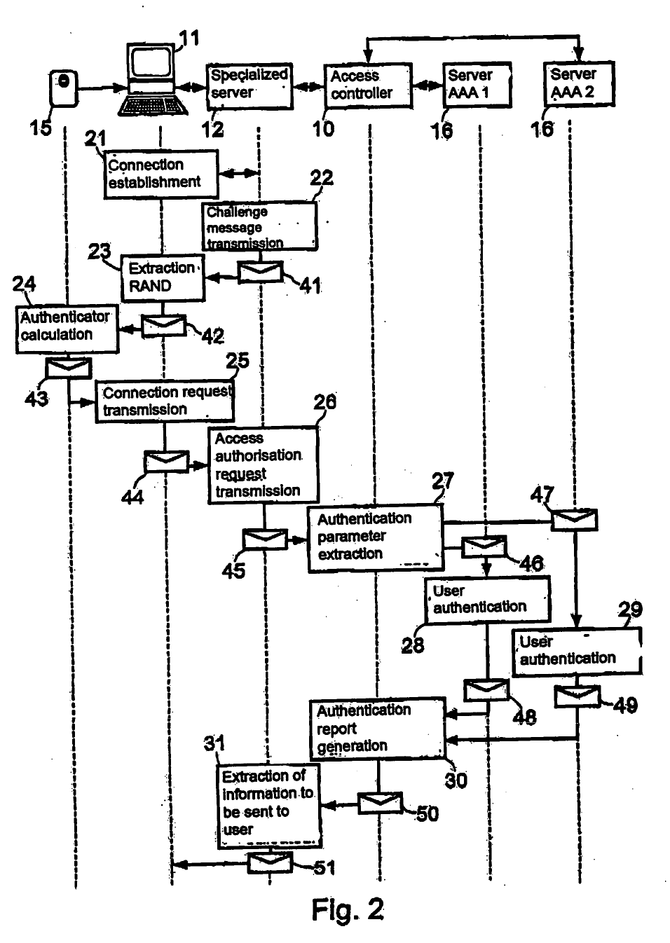

FIG. 2 shows a diagram of a series of steps carried out in the system shown in FIG. 1, according to the method of the invention.

The system shown in FIG. 1 includes access networks 1, 2 to which user terminals 11 are connected. These access networks 1, 2 provide the terminals 11 with access to an IP transport network 5 by means of respective IP gateways 3, 4 adapted to the access network. The set of access networks, gateways and the IP transport network is implemented by an ANO/ITO access network and IP transport operator.

The IP transport network 5 enables users to access an Internet access provider 6, 7 or an IP service provider 8.

To this end, according to the invention, this system includes a specialized server 12 which sends, to users who wish to connect to the IP network, random numbers intended to be used during identification procedures, and an access controller 10 connected to the IP transport network 5 and to which the specialized server 12 transmits the access requests transmitted by the terminals 11.

The access controller 10 is designed to receive all of the requests for access to an access or service provider 6, 7, 8, transmitted by the users over the networks 1, 2, by means of the gateway 3, 4 corresponding to the access network 1, 2 used, and the specialized server 12, and to direct these requests through the IP transport network to the access or service provider 6, 7, 8 indicated in the request by the user terminal.

It should be noted that the gateways 3, 4 can alternatively perform the functions carried out by the specialized server 12.

To access the IP network 5 by means of an access provider 6, 7 and a specific service provided by a service provider 8 connected to the network, the user terminal first carries out a procedure in which a connection is established with the specialized server 12 in order to obtain a random number RAND. Then the user terminal transmits an access request to the desired service provider via the access provider, which is successively transmitted by the IP gateway 3, 4 and by the specialized server 12 to the access controller 10. Upon reception of such a request, the access controller 10 asks the requested access provider 6, 7 and service provider 8 to authenticate the user. When the access provider and the service provider have sent their responds regarding the authentication of the user, the access controller transmits an access authorization response to the user terminal 11, on the basis of the authentication responses received.

The sequence of steps of the authentication method according to the invention is shown by the diagram in FIG. 2.

To access an IP service, the user terminal 11 first carries out a procedure 21 of establishing a connection with the specialized server 12 via an IP gateway 3, 4 accessible to the terminal, wherein the address of the specialized server is, for example, known from the connection software installed in the terminal. This procedure first consists of establishing a connection with the IP gateway 3, 4, for example, in accordance with the LCP protocol (Link Control Protocol). Just after opening the connection, a random number RAND is sent by the specialized server 12 to the terminal 11 (step 22), for example, in the form of a challenge message 41 in accordance with the CHAP protocol.

This random number is intended to serve as a basis for calculating passwords that can be used solely in the connection and access attempt in progress. These password calculations are advantageously based o cryptographic algorithms involving one or more secret keys and the random number RAND provided by the specialized server for the connection in progress. The cryptographic algorithms can be implemented by the user terminal, and/or preferably by a module 15 physically independent of the latter, for example, a smart card.

In this latter case, the connection software installed in the terminal is also designed to query the module 15.

The cryptographic algorithm selected is, for example, the one implanted in the SIM (Subscriber Identification Module) cards of the GSM (Global System for Mobile communications) mobile terminals.

Upon receipt of the challenge message 41, the terminal extracts the random number RAND 42 therefrom and transmits it to the module 15 connected to the terminal (step 23).

In the next step 24, the module 15 applies a cryptographic algorithm to the random number received using a secret key of the user, which makes it possible to obtain a number 43 to be used as a password for user authentication. To access more than one network entities selected by the user, namely, for example, an access provider and a service provider, the same number of passwords as entities to be accessed are preferably generated by the terminal and/or by the module 15, with the same cryptographic algorithm or with different algorithms, and with the same secret key or with different secret keys. The passwords AUTH1, AUTH2 possibly calculated by the module 15 are then transmitted in response to the terminal 11.

Of course, if one or both cryptographic algorithms are installed in the terminal, step 24 is at least partially carried out by the terminal.

Once the connection with the specialized server 12 has been established, the terminal sends an access request message 44 thereto (step 25). This request message 44 includes identifiers ID1 and ID2 for identifying the user, respectively, to the selected access and service provider, and the passwords AUTH1 and AUTH2 obtained by the cryptographic calculations.

Upon receipt of the request message 44, the specialized server 12 encapsulates this message in an access authorization request 45 (step 26). This request is, for example, of the “Access-Request” type according to the RADIUS (Remote Authentication Dial In User Service) protocol comprising a user name “User-Name” attribute identical to the two concatenated identifiers ID1|ID2, a password “CHAP-Password” attribute identical to the two concatenated passwords AUTH1|AUTH2, as well as a “CHAP-Challenge” attribute intended to receive the random number RAND used to generate the passwords, wherein the number RAND is determined by the specialized server on the basis of an identifier of the connection session in progress with the terminal. The request 45 is transmitted by the specialized server 12 to the access controller 10.

In the next step 27, the access controller receives the request 45 and extracts the identification and authentication parameters therefrom. These parameters are transmitted in steps 28, 29 in authentication messages 46, 47, respectively, to the authentication servers 16 of the selected access provider and service provider. The identification information ID1 and ID2 is, for example, in the form “IdA@domainA,” wherein “IdA” enables the user to be uniquely identified to the access or service provider, and “domainA” makes it possible to determine the domain name, in the IP network, of the server to which the corresponding authentication message is to be sent.

These authentication messages 46, 47 each contain the identifier and the password corresponding to the recipient of the message, as well as the random number RAND.

Upon receipt of such an authentication message 46, 47, the authentication server 16 carries out an authentication procedure 28, 29, respectively. This authentication procedure consists of identifying the user by means of the identification information ID1, ID2, respectively, then determining the secret key of the user by accessing a database of secret keys of authorized users, then calculating the user password using this secret key and the number RAND received, and finally, comparing the password thus calculated with the one received. To calculate the password AUTH, the authentication server has the same cryptographic algorithm as that used by the terminal 11 or the module 15.

The user is properly authenticated only if the password calculated by the authentication server is identical to the one it has received.

The result of this authentication, in the form of success/failure, is transmitted to the access controller 10 in the form of an authentication report message 48, 49, respectively.

Upon receipt of the two authentication report messages 48, 49, from the selected access provider 6, 7 and IP service provider 8, respectively, the access controller 10 has the information necessary for managing the user access rights based on the policy of the ANO/ITO operator, and carries out a step 30 of generating a message 50 in response to the access request transmitted by the user, and transmits this response message to the specialized server 12.

This response message 50 contains authentication reports transmitted by the selected access provider 6, 7 and service provider.

It should be noted that the authentication procedures 28 and 29 carried out by the access provider 6, 7 and the service provider 8 can be carried out simultaneously or sequentially in any order.

Upon receipt of the response message 50, the specialized server carries out a procedure 31 consisting of extracting, from this response message, the information to be sent to the user, the transmitting to the user terminal, in a message 51, for example, a “CHAP-success” or “CHAP-failure” message for the CHAP protocol, the extracted information to be sent to the user.

These provisions enable a user to be authenticated simultaneously by different network entities, for example, allowing Internet access in which said user has been authenticated by a secure online payment service offered, for example, by a banking institution. The user can also be authenticated by the ANO/ITO operator.

The invention described above can be obtained by implementing a specialized HTTP-type server 12 and a proxy RADIUS access controller, wherein the specialized server comprises a RADIUS interface so that it can communicate with the access controller, and the authentication servers are also RADIUS servers.

1-20. (canceled)

21. Method for authenticating a user for access to at least two entities of a data transmission network by means of a terminal, which method includes the following series of steps:
a random number is transmitted to the terminal,
data for authenticating the user to the two entities of the network is calculated using at least one predefined cryptographic algorithm applied to the random number received and at least one secret key specific to the user,
the terminal inserts, in an access request, data for identifying the user to said entities of the network and the calculated authentication data, and transmits the access request to an access controller,
the access controller transmits, to each of the two entities, a respective authentication request containing the identification data and the data for authenticating the user to said entities of the network, contained in the access request,
authentication servers of the entities carry out a user authentication procedure, on the basis of user identification and authentication data, contained in the authentication requests, and
authentication reports containing results of the authentication procedures carried out by the authentication servers of each of said network entities are transmitted to the terminal.

22. Method according to claim 21, characterized in that it includes a preliminary step in which the terminal establishes a connection with a specialized server by means of the network, wherein the random number is generated and transmitted to the terminal by the specialized server when the connection has been established.

23. Method according to claim 22, characterized in that the access request transmitted by the terminal is transmitted to the specialized server which inserts therein the random number used to calculate the authentication data, the access request is then transmitted to the access controller which inserts the random number into the authentication requests transmitted to the two entities.

24. Method according to claim 21, characterized in that the identification data inserted into the access request is in the form: “IdA@DomainA” in which:
“IdA” represents the identifier for identifying the user to the network entity,
“DomainA” represents the identifier of the network entity in the network, with the access controller determining the entities to whom the authentication requests will be transmitted on the basis of the “DomainA” identifiers of the network entity contained in the access request.

25. User terminal capable of accessing, by means of the access network, at least two entities connected to a data transmission network: characterized in that it includes:
means for transmitting access requests to an entity of the network, which requests contain data for identifying and authenticating the user to the network entity;
means for receiving a random number when a connection with the network is established, cryptographic calculating means for applying at least one predefined cryptographic algorithm to the random number received so as to obtain data for authenticating the user to at least two entities of the network, and means for inserting, into each transmitted access request, data for identifying the user to two network entities and the calculated authentication data.

26. Terminal according to claim 25, characterized in that it includes an external module-designed to be connected to each of the user terminals and including means for receiving the random number from the terminal to which it is connected, cryptographic calculation means for executing the predefined cryptographic algorithm based on the random number, and for transmitting, to the terminal, at least one data item for authenticating the user to an entity of the network, obtained by the cryptographic calculations.

27. Access controller, characterized in that it includes means for receiving requests for access to at least two entities of a data transmission network coming from user terminals and transmitted via said network, means for extracting, from each of the access requests, the data for identifying and authenticating the user to at least two network entities, means for transmitting, to each of the two entities, a respective authentication request containing the data for identifying and authenticating the user to the two entities, contained in the access request.

28. Access controller according to claim 27, characterized in that it also includes means for receiving user authentication reports, transmitted by the entities in response to the authentication requests, and means for transmitting, to the user terminal, and authentication report based on the reports received from the entities.

29. System for authenticating a user in an attempt to access at least two entities of a data transmission network to which network entities are connected, and which user terminals can access by means of access networks, characterized in that it includes:
a user terminal characterized in that it includes:
means for transmitting access requests to an entity of the network, which requests contain data for identifying and authenticating the user to the network entity; and
means for receiving a random number when a connection with the network is established, cryptographic calculating means for applying at least one predefined cryptographic algorithm to the random number received so as to obtain data for authenticating the user to at least two entities of the network, and means for inserting, into each transmitted access request, data for identifying the user to two network entities and the calculated authentication data;
at least one authentication server for each of the network entities, designed to identify and authenticate the users on the basis of identification and authentication data contained in the access requests received;
an access controller characterized in that it includes means for receiving requests for access to at least two entities of the data transmission network coming from user terminals and transmitted via said network, means for extracting, from each of the access requests, the data for identifying and authenticating the user to at least two network entities, means for transmitting, to each of the two entities, a respective authentication request containing the data for identifying and authenticating the user to the two entities, contained in the access request.

30. System according to claim 29, characterized in that it also includes a specialized server connected to the network so as to be connected to the user terminals when a connection has been established between the terminal and the network, wherein the specialized server includes means for generating and transmitting a random number to each of the terminals with which a connection is established, and means for inserting the random number into each of the access requests transmitted by the terminals.

31. System according to claim 29, characterized in that each entity of the network includes means for storing secret keys of users, means for determining the data for authenticating the user to the entity by applying the predefined algorithm to the random number received in a authentication request and to the secret user key, and for comparing the result obtained to the user authentication data received in the authentication request, wherein the user is properly authenticated by the entity only if the result of the cryptographic calculation obtained is identical to the authentication data contained in the authentication request.
